(19) United States
(12) Patent Application Publication
(10) Pub. No.: US 2008/0121209 A1
(43) Pub. Date: May 29, 2008

(54) CONTROL CABLE LINKAGE FOR A CARBURETTOR UNIT

(75) Inventors: Christian Vick, Winsen / Luhe (DE); Torge Malchau, Schonberg (DE)

Correspondence Address: KELLY LOWRY & KELLEY, LLP, 6320 CANOGA AVENUE, SUITE 1650, WOODLAND HILLS, CA, 91367, US

(73) Assignee: DOLMAR GmbH, Hamburg (DE)

(21) Appl. No.: 11/677,746

(22) Filed: Feb. 22, 2007

(30) Foreign Application Priority Data
Feb. 24, 2006 (DE) 20 2006 003 133.2

(51) Int. Cl. F02D 9/08

(52) U.S. Cl. 123/337; 261/38

(57) ABSTRACT

In order to provide a carburettor unit for an internal combustion engine, which can be used in particular for motor-driven small apparatus, including a throttle unit contained in a housing which has a throttle valve which executes a rotary movement for controlling the power of the internal combustion engine, wherein the rotary movement can be initiated by means of a control cable via a throttle valve shaft and wherein the control cable includes a control cable casing and a pull cord according to the design of a Bowden cable, which has a simple receptacle of a control cable and requires a small space for connection to the carburettor unit, it is proposed that to initiate the rotary movement in the throttle valve shaft there is provided a lever element which is disposed on the throttle valve shaft and which can be actuated by means of the pull cord and wherein a retaining device is further provided for receiving the control cable casing, which is also arranged on the throttle valve shaft.

The present invention relates to a carburettor unit for an internal combustion engine, which can be used in particular for motor-driven small apparatus, comprising a throttle unit contained in a housing which comprises a throttle valve which executes a rotary movement for controlling the power of the internal combustion engine, wherein the rotary movement can be initiated by means of a control cable via a throttle valve shaft and wherein the control cable comprises a control cable casing and a pull cord according to the design of a Bowden cable.

In motor-driven and mostly hand-guided work apparatus such as power saws, power scythes, free cutters, trimmers, lawn mowers or the like, the mixture is prepared by means of a carburettor unit. The mixture prepared in the carburettor unit is then supplied to the internal combustion engine. In order to control the output power of the combustion engine, the carburettor unit contains a throttle unit comprising a quantity control unit which regulates the amount of combustion air supplied to the combustion engine. This is achieved by means of a throttle valve which is arranged in a throttle channel and can be adjusted by a rotary movement between a closed position and an open position. The air sucked in by the carburettor is thus varied from a minimum for idling to a maximum for full-load operation at an adjusting angle of the throttle valve of about 90°. In order to implement a simple carburettor unit which can be produced at low cost, this is triggered mechanically, i.e. the throttle valve is adjusted by means of a Bowden cable or a corresponding rod.

In relation to the use of a Bowden cable, the user can vary the power of the combustion engine by means of a gas lever, the gas lever usually being arranged as a handle of the work apparatus and the Bowden cable running between the gas lever and the carburettor unit. The Bowden cable consists of a control cable casing which contains a pull cord such that this can be displaced axially. The control cable casing with the pull cord running therein is flexible and can thus be laid, for example, on the frame of the work apparatus. The pull cord usually transmits tensile forces to adjust an adjusting member such as a lever element or similar. In this case, a counterforce is produced in the control cable casing, which is manifest as a compressive force in said casing. The control cable casing is thus a type of opposite pole for the translational force in the pull cord so that a corresponding retaining device is required for the control cable casing.

When coupling the Bowden cable to a carburettor unit, the pull cord is initially suspended in the lever element to produce a rotary movement at said element through the translational movement of the pull cord, which rotary movement initiates the turning movement of the throttle valve. The end of the pull cord usually comprises a cylindrical or cubic element which is suspended in a receiving fork formed on the lever element, which can be designated as a cable lock. A counter-moment which counteracts the translational pull movement of the pull cord is initiated on the lever element to maintain the tensile force in the pull cord by means of a spring such as a torsion spring or a spiral tension spring. The tensile force in the pull cord is thus maintained in each adjusting position, the counterforce in the control cable casing being introduced as a compressive force in the retaining device.

The throttle valve is arranged on a throttle valve shaft which is guided out from the housing of the carburettor unit with one shaft end, a further shaft frequently being provided and guided out from the housing which is connected to the throttle valve shaft by means of a toothed structure. The lever element for initiating the turning movement is arranged in a torsion-resistant manner on the shaft which is guided out of the housing, the pull cord being suspended in the lever element. The retaining device of the control cable casing is rigidly fixed to the carburettor unit, the fixing frequently being made by means of a single fixing element on the housing of the carburettor unit or on a modification part.

DE 100 56 714 A1 discloses an adjusting device for a carburettor control cable of an internal combustion engine for a hand-guided work apparatus, where a pull cord of the carburettor control cable designed as a Bowden cable acts on the carburettor of the engine. In this case, the carburettor is fixed to the inlet of the combustion engine by inserting a spacer piece, a tensioning piece of the tensioning device being mounted pivotally on the spacer piece by means of a bolt. In sections the pull cord lies on the pivotable arm of the tension piece, the position of the tension piece being adjustable by means of a position screw which can be screwed-on from the pivoting arm in the direction of a support. In particular, the control cable casing of the Bowden cable is supported axially in a casing lock and the axially movable pull cord is guided over the tension piece to the carburettor to transmit the desired control pulses to the throttle valve of the carburettor. In this case, the pull cord holds the tension piece with its lever arm resting on the spacer piece.

DE 100 10 869 A1 discloses a further embodiment relating to the application of a Bowden cable. This relates to a hand-guided work apparatus having a movable control element for influencing the operation of the work apparatus, with an actuatable positioning element and a Bowden cable connecting the positioning element and the control element. The Bowden cable comprises a cable casing and a pull cord which can be moved axially in the cable casing. The cable casing is held at its two ends in fixed support locations on the apparatus, each having a longitudinal stop.

In the known embodiments for receiving the control cable casing, the problem arises that the required retaining device for receiving the control cable casing requires considerable space, which is frequently not available in very compact, motor-driven small apparatus. Spacer pieces having the correspondingly required casing lock are frequently required. As soon as this is located between the housing of the carburettor and the lever element, the throttle valve shaft must accordingly be guided further out of the housing of the carburettor and made longer. Thus, the required space also increases, and when fixing the retaining element to one of the conversion parts such as the base body of the motor-driven small apparatus, the required space must also be larger. The designs of these retaining devices are frequently very complex on account of their complex geometries and an aluminium compression casting is frequently used with regard to the manufacturing method or the retaining device is constructed as a stamped bending part.

It is thus the object of the present invention to provide a carburettor unit for an internal combustion engine which has a simple receptacle for a control cable and requires little space for connection to the carburettor unit.

This object is achieved starting from the carburettor unit for an internal combustion engine according to the preamble of claim 1 in conjunction with its characterising features. Advantageous further developments of the invention are specified in the dependent claims.

The invention includes the technical teaching that to initiate the rotary movement in the throttle valve shaft there is provided a lever element which is disposed on the throttle valve shaft and which can be actuated by means of the pull cord and wherein a retaining device is further provided for receiving the control cable casing, which is also arranged on the throttle valve shaft.

In this case, the invention starts from the idea that both the lever element and also the retaining device are fixed on the throttle valve shaft itself to avoid an additional fixing element to be attached. The throttle valve shaft serves at the same time as a receptacle, in particular for the retaining device, wherein this has a bore through which the throttle valve shaft extends. The retaining device can be arranged on the throttle valve shaft on the housing side and followed adjacent thereto on the throttle valve shaft by the lever element, and an arrangement where the lever element is provided on the housing side and the retaining device for the control cable casing is arranged at the end on the throttle valve shaft is also possible.

The diameter of the bore in the retaining device can be matched to the diameter of the throttle valve shaft so that this arrangement can be regarded as a sliding bearing. In a defined radius to the bore, the retaining device has a fork-shaped casing lock comprising a cylindrical indentation into which the end of the control cable casing can be inserted. The cylinder has a slot formed on one side through which the pull cord can be guided on joining so that in the assembled state, this can be guided out from the casing lock at the front. The casing lock of the Bowden cable in the lever element is advantageously located in the same plane as the cable lock so that the pull cord is not exposed to any oblique pull. Thus, the casing lock can have an offset at the retaining device relative to the central bore so that it is located in the mounting plane of the lever element. The retaining device can be fabricated as an aluminium compression casting, as a stamped bending part, as a machined component or similar, a combination of said production methods also being possible. In this case, the body of the retaining device substantially corresponds to a flat disk with a central bore and a casing lock formed on the outside, this having the offset relative to the region of the flat disk.

As an advantageous further development of the invention, it is provided that the retaining device is secured against twisting on the throttle valve shaft by means of an anti-rotation element. The anti-rotation element is necessary to secure the torque produced between the pull cord and the control cable casing about the axis of the throttle valve shaft. Since the retaining device can be turned in a simple mounting on the throttle valve shaft, securing against twisting is required to locate the retaining device in a fixed position with respect to the housing of the carburettor unit. This anti-rotation element is constructed, for example, as a screw connection of the retaining device to the housing of the carburettor unit, where the screw is screwed into the wall of the carburettor unit from which the throttle valve shaft extends. The anti-rotation unit would thus be releasable again at any time, and is at the same time used as axial securing for the retaining device. A simple bolt locking device where the bolt is inserted into the wall of the housing is also possible. The anti-rotation element can comprise a plurality of screws or bolt connections between the housing of the carburettor arrangement and the retaining device, where the retaining device can be held mechanically completely by the anti-rotation element so that this no longer needs to be centred conclusively on the throttle valve shaft by means of its bore in order to avoid complex play or transition matching to produce a sliding bearing. In the case of a housing-side arrangement on the throttle valve shaft, the retaining device can abut flat against the housing and be screwed to said housing to ensure optimal usage of space.

An alternative embodiment of the anti-rotation element of the retaining device provides that the anti-rotation element comprises a holding pawl formed on the retaining device which is inserted positively in the housing of the carburettor unit. As a result, additional components forming the anti-rotation element are omitted since screw connections, bolts or similar connecting elements are no further required. The spring-groove connection in this case comprises a holding pawl formed on the retaining device. This can be formed, for example, as a pawl continuation in the retaining device which is particularly advantageous when the retaining device is designed as a stamped bending part. In a component produced by compression casting, on the other hand, a key-like formation which projects into a corresponding groove in the housing wall is suitable. The position of the retaining device is thus fixed in the direction of rotation and a moment can be introduced into the retaining device without any twisting. By means of corresponding formations on the retaining device, it is also possible to lock this in the radial position so that in this embodiment of the anti-rotation element, centring of the retaining device on the throttle valve shaft is no longer required so that this can also run freely through the central bore in the retaining device in this embodiment. Loosening of the spring-groove connection on the housing side can be avoided by securing the retaining device axially on the throttle valve shaft, the securing being made against the lever element on the shaft end side and by the housing wall on the housing side.

A further measure which improves the present invention provides that the retaining device and the lever element are arranged nested within one another on the throttle valve shaft. In this case, the two elements are arranged flat and parallel, adjacent to one another, on the shaft, and the formations on the retaining device such as the anti-rotation element and in particular, the casing lock project into the mounting of the lever element, which is advantageous with regard to straight cable guidance. Furthermore, the connection between retaining device and lever element can comprise a torsion spring which can restore the lever element against the pulling movement of the pull cord. The torsion spring can advantageously be arranged between the retaining device and the lever element so that a particularly high integration density is achieved and the interface between the throttle valve shaft and the Bowden cable as a compact unit is also suitable for other applications where a rotational movement is generally produced in a shaft which extends from a housing wall or another wall.

The lever element advantageously has a circular disk contour around which the pull cord is looped in order to achieve a uniform rotary movement of the throttle valve shaft with the axial movement of the pull cord. In this case, the pull cord is unwound from the disk contour during an axial pulling-in movement of the pull cord into the control cable casing, the radius of the disk contour being adapted so that the desired ratio of pulling-in and rotary movement is produced. The larger the radius which is selected, the smaller is the angle segment within which the throttle valve shaft turns for a given translational distance of the pull cord. In this case, the disk contour can also have a variable radius so that the rotary movement is not linearly dependent on the translational movement of the pull cord. The cable lock is advantageously arranged at the end of the circular disk contour so that the pull cord runs into the cable lock after looping around the disk contour and is secured there.

According to a possible further development of the invention, it is proposed that the throttle valve shaft has a securing element which is detachably affixed at the end on the throttle valve shaft by means of an axially arranged screw. The securing element is embodied as a stamped bending part and can co-rotate with the lever element. In this case, this element can fulfil the function of a locking device for fixing a predefined gas position, and for example, a moulded-on pawl can hook into a correspondingly adjacent device. The components arranged on the throttle valve shaft can be secured by means of a screw inserted axially into the throttle valve shaft at the end, which rests on the securing element and finally screws this in a package arrangement with at least the lever element and the retaining device.

Further measures which improve the invention are specified in the dependent claims or are explained in detail hereinafter jointly with the description of a preferred exemplary embodiment of the invention with reference to the figures. The figures show in a purely schematic view:

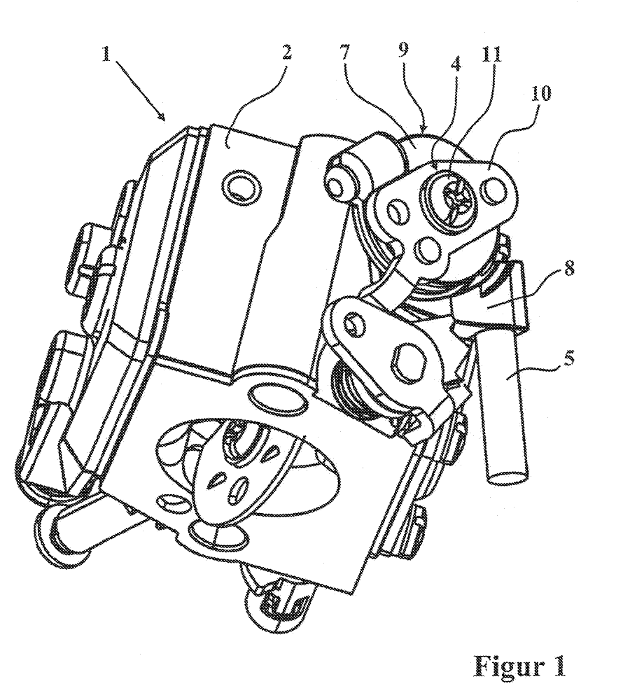

FIG. 1 a first perspective view of a carburettor unit with triggering via a Bowden cable,

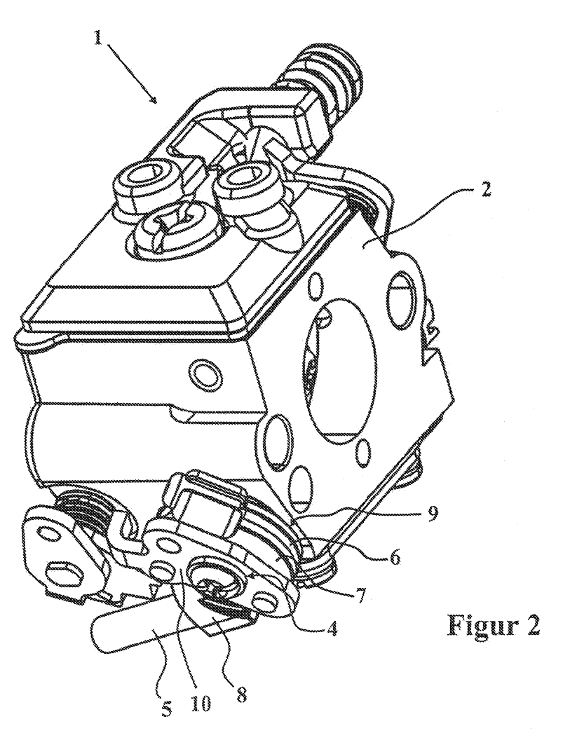

FIG. 2 shows a second perspective view of the carburettor unit from FIG. 1,

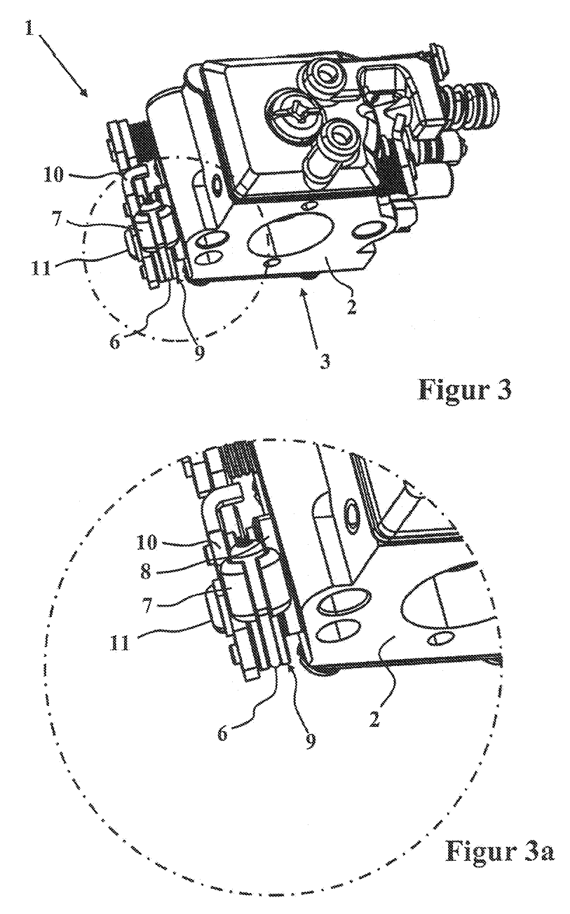

FIG. 3 shows another perspective view of the carburettor unit from FIG. 1 and

FIG. 3a shows an enlarged section of the carburettor unit from FIG. 3 showing the arrangement of the Bowden cable on the carburettor unit.

The figures merely comprise an exemplary technical embodiment of the present invention.

The carburettor unit 1 shown in FIGS. 1 to 3 substantially comprises a housing 2 on which a control cable designed as a Bowden cable is arranged. The control cable actuates a throttle valve 3 which is mounted rotatably on a throttle valve shaft 4. The throttle valve 3 is located in a throttle channel so that the amount of combustion air supplied to the internal combustion engine can be varied depending on the position of the throttle valve. The rotary movement is initiated by a pull cord 6 guided in the control cable casing 5, where the pull cord 6 executes a translational movement and the movement is converted into the rotary movement by means of a lever element 7, the lever element 7 being located in a torsion-resistant manner on a section of the throttle valve shaft 4 so that it can transmit the required torque.

The lever element 7 has a cable lock in which there is suspended a cylindrical or cubic element securely connected to the pull cord 6 at the end. During a pulling-in movement of the pull cord 6 into the control cable casing 5, the lever element 7 executes a rotary movement which, according to the present embodiment of the invention, turns the throttle valve 3 such that the output power of the combustion engine increases. During a run-out movement of the pull cord 6 from the control cable casing 5, the throttle valve 3 twists in the other direction so that the output power of the combustion engine falls again. The backward movement is introduced into the system by means of a spring which counteracts the pulling movement of the pull cord 6.

The control cable casing 5 is held in a casing lock which is formed on a retaining device 8. The retaining device 8 like the lever element 7 is disposed on the throttle valve shaft 4, the retaining device 8 being located between the housing 2 and the lever element 7. In this case, the retaining device 8 is designed such that this is arranged in a nested manner with the lever element 7 and the casing lock on the retaining device 8 is located in a plane with the cable lock on the lever element 7. The pull cord 6 emerges from the casing lock of the control cable casing 5 and loops around the disk contour 9, allowing a uniform rotary movement of the throttle valve shaft 4 relative to the translational movement of the pull cord 6. The disk contour 9 is formed on the lever element 7, the cable lock following directly at the rear end of the disk contour 9.

A securing element 10 is placed at the end of the throttle valve shaft 4, this element being secured on the shaft by means of a screw 11. Thus, all the components are secured axially on the region of the throttle valve shaft 4, and the throttle valve shaft 4 substantially receives all the components required for connection of the Bowden cable.

The present invention is not restricted in its embodiment to the preferred exemplary embodiment specified hereinbefore. Rather, it is feasible to have a number of variants which also make use of the solution presented in fundamentally different types of embodiments.

REFERENCE LIST

1 Carburettor unit

2 Housing

3 Throttle valve

4 Throttle valve shaft

5 Control cable casing

6 Pull cord

7 Lever element

8 Retaining device

9 Disk contour

10 Securing element

11 Screw

1. A carburettor unit (1) for an internal combustion engine, which can be used in particular for motor-driven small apparatus, comprising a throttle unit contained in a housing (2) which comprises a throttle valve (3) which executes a rotary movement for controlling the power of the internal combustion engine, wherein the rotary movement can be initiated by means of a control cable via a throttle valve shaft (4) and wherein the control cable comprises a control cable casing (5) and a pull cord (6) according to the design of a Bowden cable, characterised in that to initiate the rotary movement in the throttle valve shaft (4) there is provided a lever element (7) which is disposed on the throttle valve shaft (4) and which can be actuated by means of the pull cord (6) and wherein a retaining device (8) is further provided for receiving the control cable casing (5), which is also arranged on the throttle valve shaft (4).

2. The carburettor unit according to claim 1, characterised in that the retaining device (8) is secured against twisting on the throttle valve shaft (4) by means of an anti-rotation element.

3. The carburettor unit according to claim 2, characterised in that the anti-rotation element comprises a screw connection which can be screwed into the housing (2) of the carburettor unit (1).

4. The carburettor unit according to claim 2, characterised in that the anti-rotation element comprises a holding pawl formed on the retaining device (8) which is inserted positively in the housing (2) of the carburettor unit (1).

5. The carburettor unit according to claim 1, characterised in that the retaining device (8) is secured on the throttle valve shaft (4), wherein the axial securing is effected on a housing side by the housing (2) and on a shaft end side by the lever element (7).

6. The carburettor unit according to claim 1, characterised in that the retaining device (8) and the lever element (7) are arranged nested within one another on the throttle valve shaft (4).

7. The carburettor unit according to claim 1, characterised in that the lever element (7) has a circular disk contour (9) around which the pull cord (6) is looped in order to achieve a uniform rotary movement of the throttle valve shaft (4) with the axial movement of the pull cord (6).

8. The carburettor unit according to claim 1, characterised in that the throttle valve shaft (4) has a securing element (10) which is detachably affixed at the end on the throttle valve shaft (4) by means of an axially arranged screw (11).

9. The carburettor unit according to claim 2, characterised in that the retaining device (8) is secured on the throttle valve shaft (4), wherein the axial securing is effected on a housing side by the housing (2) and on a shaft end side by the lever element (7).

10. The carburettor unit according to claim 9, characterised in that the retaining device (8) and the lever element (7) are arranged nested within one another on the throttle valve shaft (4).

11. The carburettor unit according to claim 10, characterised in that the lever element (7) has a circular disk contour (9) around which the pull cord (6) is looped in order to achieve a uniform rotary movement of the throttle valve shaft (4) with the axial movement of the pull cord (6).

12. The carburettor unit according to claim 11, characterised in that the throttle valve shaft (4) has a securing element (10) which is detachably affixed at the end on the throttle valve shaft (4) by means of an axially arranged screw (11).
